(19) United States
(12) Patent Application Publication
(10) Pub. No.: US 2009/0150116 A1
(43) Pub. Date: Jun. 11, 2009

(54) METHOD FOR AUTOMATICALLY SETTING INITIALLY-ESTIMATED ROTATIONAL FREQUENCY IN MOTOR FREQUENCY MEASURING SYSTEM

(76) Inventor: Ching-Yi LIN, Taoyuan Shien (TW)

Correspondence Address: HDLS Patent & Trademark Services, P.O. BOX 220746, CHANTILLY, VA, 20153-0746, US

(21) Appl. No.: 11/950,693

(22) Filed: Dec. 5, 2007

(51) Int. Cl. G01P 3/481

(52) U.S. Cl. 702/145; 702/78; 702/79

(57) ABSTRACT

A method automatically sets initially-estimated rotational frequency for a motor frequency measuring system based on pulse signals output from an encoder. Initially, a counter is reset to zero, and a count threshold and an initially-estimated rotational frequency are set. The possible motor frequencies are divided into multiple frequency ranges with specific starting frequencies. A pulse width threshold is set according to the initially-estimated rotational frequency. A new motor frequency is calculated by the count threshold and a corresponding elapsed time. The initially-estimated rotational frequency is set to be a frequency in a frequency range higher than the new motor frequency. Therefore, the initially-estimated rotational frequency can be adaptively set according to an updated frequency measurement. Moreover, the count threshold can be monotonously increased with the updated frequency measurement to enhance measurement accuracy.

### BACKGROUND OF THE INVENTION

1. Field of the Invention

The present invention relates to a method used in motor frequency measuring system, especially to a method for automatically setting initially-estimated rotational frequency in motor frequency measuring system.

2. Description of Prior Art

Speed measurement is inevitable for close loop control of motor. For speed measurement of motor, an encoder is used to measure the rotational speed of motor rotor.

FIG. 1 shows the block diagram of a prior art AC motor controlling system, which controls the speed of a motor 10a based on a feedback measured speed of motor. A speed estimation device 20a comprises a counter 22a and a speed estimation unit 24a. An encoder 12a outputs a pulse signal to represent a measured motor position. The counter 22a processes the pulse signal to obtain a position signal P for the motor. The speed estimation unit 24a processes the position signal P of the motor to obtain a motor rotational speed V_{LPF}. A position control unit 40a generates a speed command V_{cmd} based on a position command P_{cmd} and a feedback from the counter 22a. A speed control unit 30a generates a current command i_{cmd} based on the speed command V_{cmd} and sends the current command i_{cmd} to a current controlling and driving unit 50a. The current controlling and driving unit 50a accordingly drives the motor 10a based on the current command i_{cmd}.

With reference to FIGS. 2 and 3, the processing principle and processing steps for the prior art speed estimation unit 24a are illustrated. As shown in FIG. 2, the prior art speed estimation unit 24a uses a displacement within a unit time to calculate the speed V(t) of the motor

$$V ( t ) = \frac{P ( t ) - P ( t - T )}{T} ,$$

wherein V (t) is an estimated speed, P (t) is a feedback counted position of the encoder and T is sampling time. As shown in FIG. 3, at each sampling time T (step S10), the speed estimation unit 24a reads a counted position P(t) from the counter (step S12). The speed estimation unit 24a then subtracts the position P(t−T) of previous sample from the current position P(t) (step S14). The speed estimation unit 24a divides the position difference by the sampling time T to obtain an initial speed

$$V ( t ) = \frac{P ( t ) - P ( t - T )}{T}$$

(step S16). The initial speed is processed by a low pass filter for smoothing treatment to obtain a final speed estimation V_{LPF} (step S18).

US patent publication 20070043528 A1 discloses a method for averaging speed estimations based on multiple sampling periods to reduce ripple, where a moving average window is used. However, this prior art method cannot solve the phase delay problem when the motor is operated at high speed.

In measuring speed of motor, an initially-estimated speed is necessary for measurement, where the initially-estimated speed is generally the highest detectable speed for the measurement system. Because the speed of motor is measured in terms of rotational frequency, the term “speed” is referred to as “frequency” for remaining of the specification. Moreover, the information of the highest frequency for the article to be measured is also necessary. Otherwise measurement error may occur and the measurement error has following two possibilities.

1. A high-frequency initial estimation is used for an article with low frequency. The noise immunity ability is degraded such that noise will induce measurement error.

2. A low-frequency initial estimation is used for an article with high frequency. The measured frequency is lower than the actual frequency because some timing pulses are not counted.

When the rotational speed (rotational frequency) of an article to be measured is not a fixed value, the initially-estimated frequency is difficulty to set for the article with a varying frequency range. It is desirable to provide a method for automatically setting initially-estimated rotational frequency in motor frequency measuring system.

### SUMMARY OF THE INVENTION

The object of the present invention is to provide a method for automatically setting initially-estimated rotational frequency in motor frequency measuring system.

Accordingly, the present invention provides a method automatically setting initially-estimated rotational frequency for a motor frequency measuring system based on pulse signals output from an encoder. Initially, a counter is reset to zero, and a count threshold and an initially-estimated rotational frequency are set. The possible motor frequencies are divided into multiple frequency ranges with specific starting frequencies. A pulse width threshold is set according to the initially-estimated rotational frequency. A new motor frequency is calculated by the count threshold and a corresponding elapsed time. The initially-estimated rotational frequency is set to be a frequency in a frequency range higher than the new motor frequency. Therefore, the initially-estimated rotational frequency can be adaptively set according to an updated frequency measurement. Moreover, the count threshold can be monotonously increased with the updated frequency measurement to enhance measurement accuracy.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the block diagram of a prior art AC motor controlling system, which controls the speed of a motor 10a based on a feedback measured speed of motor.

FIG. 2 demonstrates the principle of the prior art speed estimation unit.

FIG. 3 shows processing steps for the prior art speed estimation unit.

FIG. 4 shows the block diagram of a motor frequency measuring system according to a preferred embodiment of the present invention.

FIG. 5 shows the timing diagram of pulse signal generated from the encoder.

FIG. 6 shows the flowchart of the method for automatically setting initially-estimated rotational frequency in motor frequency measuring system.

FIG. 7 shows the example of frequency ranges.

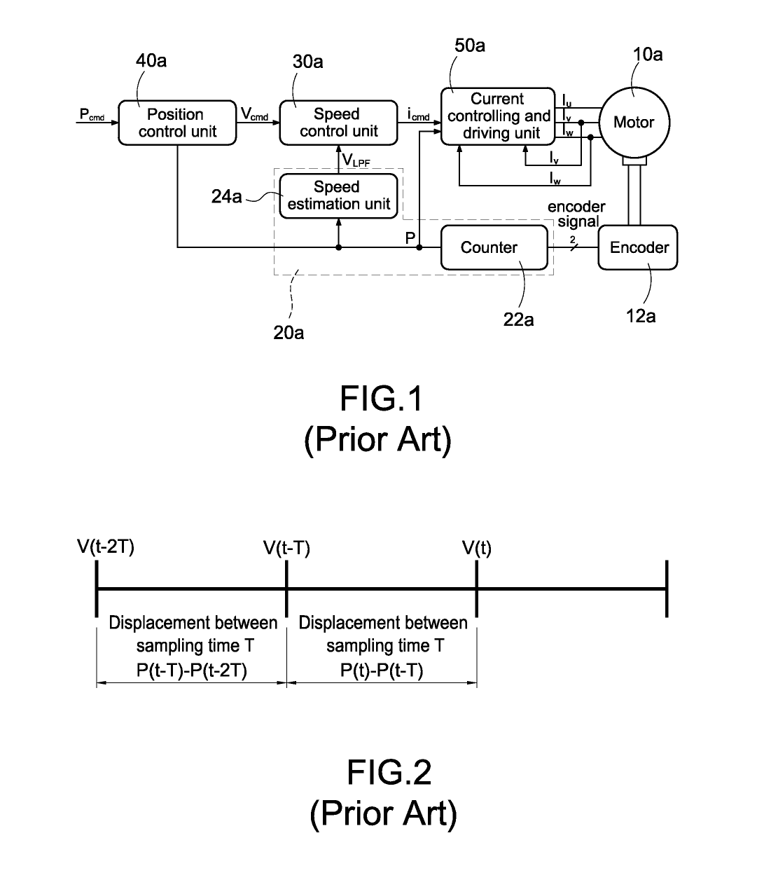

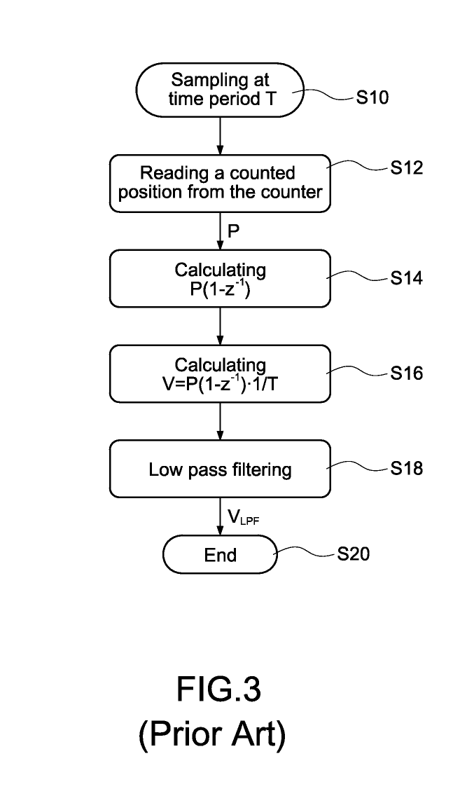

### DETAILED DESCRIPTION OF THE INVENTION

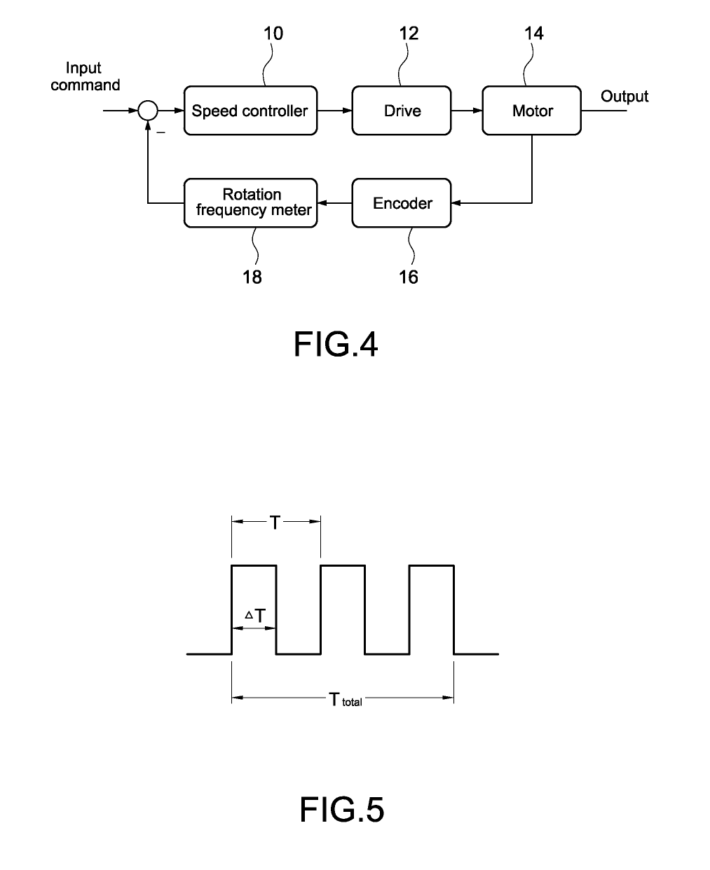

FIG. 4 shows the block diagram of a motor frequency measuring system according to a preferred embodiment of the present invention. The motor frequency measuring system mainly comprises a speed controller 10, a rotation frequency meter 18 and an encoder 16. The encoder 16 is linked with a rotor of the motor 14 and generates pulse signals based on the rotation of the motor rotor. The rotation frequency meter 18 estimates the rotational frequency of motor rotor in terms of rotational frequency and based on the pulse signals. The rotation frequency meter 18 sends the estimated rotational frequency to the speed controller 10. The speed controller 10 processed the estimated rotational frequency and an input speed command to generate a speed command. The speed command is then send to a driver 12 to precisely control the speed of the motor rotor.

FIG. 5 shows the timing diagram of pulse signal generated from the encoder 16. The period of the pulse signal is defined as time interval T (time period between two adjacent pulses). There are two important parameters for measuring rotation frequency of motor rotor, namely, elapsed time and pulse number. The frequency can be measured from the pulse number per second (Hz). The commercially available rotation speed meter generally counts the rotation frequency in turns of rpm (revolution per minute) or rps (revolution per second). Provided that n pulses are generated for on revolution, 1 rpm is equal to n/60 Hz and 1 rps is equal to n Hz. The rotation frequency meter 18 uses hardware interrupt to start the timing clock when a pulse is sensed and stops the timing clock when another pulse is sensed. Therefore, the time interval T between two pulses can be calculated. When the measurement is performed for N pulses and the total time interval is Tₜₒₜₐₗ, the motor rotor frequency is N/(Tₜₒₜₐₗ)Hz.

In above measurement process, pulse width threshold ΔT is generally used to overcome the interference of noise. A pulse with pulse width smaller than the pulse width threshold ΔT is treated as noise and is not processed. The pulse width threshold ΔT is relevant to a preset rotation frequency set by user. When the preset rotation frequency set by user is larger, the pulse width threshold ΔT is smaller. The pulse width threshold ΔT is set to be smaller than half of a period deduced from the preset rotation frequency set by user. For example, when the preset rotation frequency set by user is 1 KHz, then the pulse width threshold ΔT should not be larger than 1/(1 k×2)=0.5 (ms).

The preciseness of measurement for rotor frequency can be enhanced when the user sets a correct pulse width threshold ΔT, namely, the user set a correct preset rotation frequency, which is close to actual speed. However, the above example is demonstrated for rotor with fixed frequency. When the rotation frequency is not correctly preset, measurement error will occur.

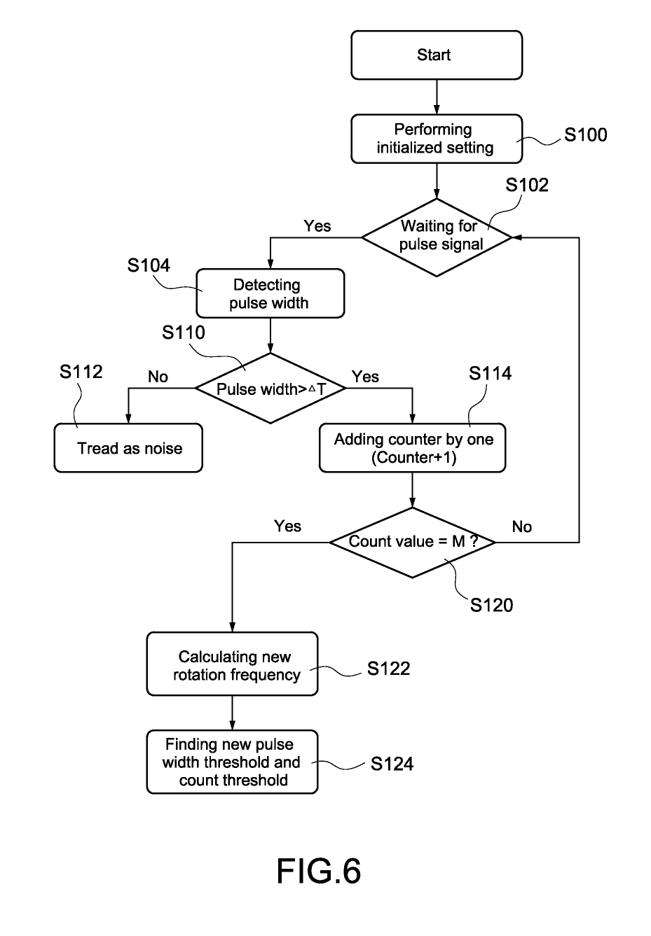

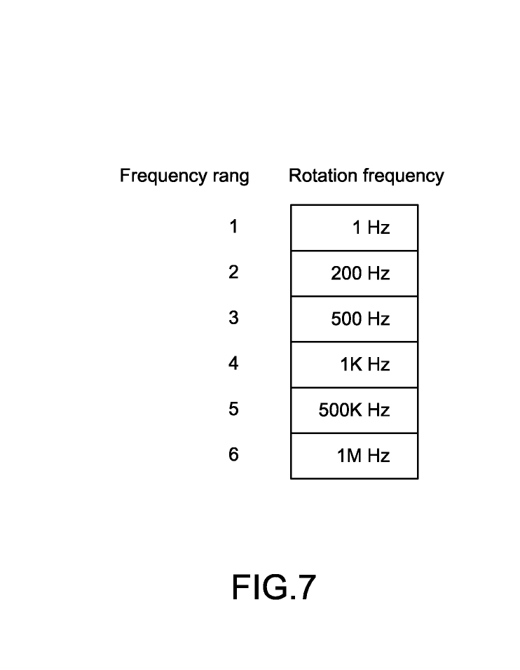

In the present invention, the continuous property of motor frequency is exploited. Therefore, the initially-estimated rotational frequency is automatically set instead of setting with a constant value. FIG. 6 shows the flowchart of the method for automatically setting initially-estimated rotational frequency in motor frequency measuring system. According to the present invention, two parameters are automatically set, namely, the pulse width threshold ΔT and the count threshold M. Moreover, an initially-estimated frequency lookup table is set up in advance. The rotor frequency is changed gradually and is not changed abruptly. Therefore, the rotor frequency will not change from 1 Hz to 100 Hz instantaneously. The possible rotor frequency is divided to a plurality of ranges from the lowest detectable frequency to the highest detectable frequency by the motor speed measuring system. With reference to FIG. 7, the rotor frequency is divided to ranges with boundaries 1 Hz, 200 Hz, 500 Hz, 1 KHz, 500 KHz and 1 MHz etc. A specific time interval is associated with each of the frequency ranges. For example, the specific time intervals can be 1/(1 Hz), 1/(200 Hz) . . . 1/(1 MHz) etc. A next initially-estimated rotational frequency is set according to a current speed range. More specifically, the next initially-estimated rotational frequency is higher than the current frequency range by one level.

For example, if a beginning boundary frequency of a frequency range is set to be 5 KHz and the duty cycle for the boundary frequency of 5 KHz is ⅕ K=0.2 mS. The pulse width threshold ΔT associated with the boundary frequency of 5 KHz is half of the duty cycle, namely, 0.1 mS. Therefore, a detect pulse with pulse width smaller than 0.1 mS will be treated as noise and ignored by the rotation frequency meter 18.

In step S100, an initially-estimated rotational frequency is set for precise frequency measurement. When the frequency measurement is first conducted (no measurement data before), the initially-estimated rotational frequency is set as the highest detectable frequency of the motor frequency measuring system. When there is measurement data before, the initially-estimated rotational frequency is set as the frequency range higher than the current frequency range by one level. For example, if the current measured frequency is 190 Hz, the measured frequency is close to the frequency ranged started from 200 Hz (the second range). Therefore, the initially-estimated rotational frequency for a next measurement is set as the starting frequency in a higher range (500 Hz, the third range). The pulse width threshold ΔT is set according to the starting frequency of 500 Hz. If the current measured speed is 10 Hz, the measured frequency is close to the frequency range started from 1 Hz (the first range). Therefore, the initially-estimated rotational frequency for a next measurement is set as the starting frequency in a higher range (200 Hz, the second range). The pulse width threshold ΔT is set according to the starting frequency of 200 Hz. Moreover, the rotation frequency meter 18 is provided with a counter (not shown). In the time of setting the initially-estimated rotational frequency, the counter is reset to zero.

After the initially-estimated rotational frequency is set up, the rotation frequency meter 18 detects the incoming of a pulse in step S102. After detecting a pulse, the rotation frequency meter 18 detects the time interval of the pulse by hardware interrupt to measure the pulse width in step S104. The rotation frequency meter 18 compares the pulse width of currently measured pulse with the pulse width threshold ΔT in step S110. When the pulse width of currently measured pulse is not larger than the pulse width threshold ΔT, the currently measured pulse is ignored as noise in step S112. When the pulse width of currently measured pulse is larger than the pulse width threshold ΔT, the counter is added by 1 in step S114. Afterward the rotation frequency meter 18 compares the counter value with the set count threshold M. When the counter value is equal to the count threshold M, the measurement is stopped and new motor frequency is calculated in step S122, wherein new motor frequency is M/Tₜₒₜₐₗ (Hz) and Tₜₒₜₐₗ is the total elapsed time for this measurement. The rotation frequency meter 18 uses the new motor frequency to update the pulse width threshold ΔT and the count threshold M. The count threshold M can be proportional to the measured motor frequency or be a fixed value. The count threshold M can be preferably monotonously increasing with the measured motor frequency. For example, the count threshold M is 200 when the measured motor frequency exceeds 200 Hz. The count threshold M is 1 when the measured motor frequency is below 200 Hz.

In the method for automatically setting initially-estimated rotational frequency in motor speed measuring system, the pulse width threshold ΔT is automatically set according to a previous measurement. The count threshold M is monotonously increasing with the measured motor frequency. Therefore, the method of the present invention can precisely measure the motor frequency without the problem resulted from fixed starting motor frequency estimation.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for automatically setting initially-estimated rotational frequency in a motor frequency measuring system, comprising:
performing an initialized setting to reset a count value, and to set an initially-estimated rotational frequency and a count threshold, wherein the initially-estimated rotational frequency is the highest detectable frequency of the motor frequency measuring system for a first measurement;
dividing possible motor frequencies into a plurality of frequency ranges with specific starting frequencies;
calculating a pulse width threshold according to the initially-estimated rotational frequency;
counting pulse numbers within a total elapsed time according to the pulse width threshold, wherein the pulse numbers are counted by the count value;
calculating a new motor frequency based on the pulse numbers and the total elapsed time; and
setting a new initially-estimated rotational frequency according to the new motor frequency, wherein the new initially-estimated rotational frequency is larger than the new motor frequency.

2. The method in claim 1, wherein the plurality of frequency ranges are frequency ranges separated by starring frequencies of 1 Hz, 200 Hz, 500 Hz, 1 kHz, 500 kHz, and 1 MHz.

3. The method in claim 1, further comprising:
receiving a pulse signal and counting a pulse width for the pulse signal; and
adding the count value by one when the pulse width for the pulse signal is larger than the pulse width threshold.

4. The method in claim 3, wherein the total elapsed time is the time when the pulse number reaches the count threshold.

5. The method in claim 1, wherein the new initially-estimated rotational frequency is a speed in a frequency range higher than a current frequency range by one level.

6. The method in claim 1, further comprising:
using the new initially-estimated rotational frequency to set a new count threshold, wherein the new count threshold is in monotone increase with the new initially-estimated rotational frequency.

7. The method in claim 1, wherein the pulse width threshold is 50% period corresponding to the initially-estimated rotational frequency.

8. The method in claim 1, wherein the plurality of frequency ranges are between a lowest detectable rotation frequency and a largest detectable rotation frequency.
